(19) United States
(12) Patent Application Publication
(10) Pub. No.: US 2010/0034770 A1
(43) Pub. Date: Feb. 11, 2010

(54) ANTIMICROBIAL SURFACES

(76) Inventor: Patrick Daniel Mize, Durham, NC (US)

Correspondence Address: CHARLES T. JOYNER, PLLC, 7515 JOHNSON MILL ROAD, BAHAMA, NC, 27503, US

(21) Appl. No.: 12/537,188

(22) Filed: Aug. 6, 2009

Related U.S. Application Data
(60) Provisional application No. 61/188,350, filed on Aug. 8, 2008.

(51) Int. Cl. A01N 43/16; A01P 1/00

(52) U.S. Cl. 424/78.31

(57) ABSTRACT

The present invention relates to compositions having a light activated antimicrobial material connected to an environmental surface, such as fabric, through a linking moiety and a mediator polymer. Also taught herein are surfaces to which the compositions of this invention are attached to impart antimicrobial activity to those surfaces. The present invention facilitates or makes possible the attachment of certain light activated antimicrobial material such as Rose Bengal dye to a surface to achieve antimicrobial activity.

### CROSS REFERENCE TO RELATED APPLICATION

This application is related to and claims priority to U.S. Provisional Application Ser. No. 61/188,350, filed Aug. 8, 2008, entitled An Antimicrobial Surface, and the disclosure of this provisional application is incorporated herein in its entirety.

### BACKGROUND OF THE INVENTION

1. Field of the Invention

The present invention relates to light activated antimicrobial surfaces.

2. Description of Related Art

An antimicrobial agent is a drug, chemical, or other substance that kills microbes (i.e., microorganisms), prevents the growth of microbes, or slows the growth of microbes. Example microbes are bacteria, fungi, viruses, and the like, which are responsible for almost all of the common infectious diseases from athlete's foot, to AIDS, to ulcers. Example antimicrobial agents include antibacterial drugs, antiviral drugs, antifungal drugs, and antiphrastic drugs.

Decontamination of microbes is typically carried out by surfactants, irradiation, exposure to solvents, or exposure to agents that cause oxidative damage to biological macromolecules. These latter treatments include bleach and gases, such as ethylene oxide and chlorine dioxide. In the environments in which human beings are present, the use of irradiation either with gamma rays or high intensity UV irradiation is undesirable, as is the exposure of human beings to organic solvents and noxious gases.

Certain materials, in particular certain dyes, such as porphyrins, fluorescenes, phenothiaziniums, and phthalocyanines, generate high energy state singlet oxygen, a potent antimicrobial, when exposed to light and air. These materials are often referred to as “light-activated antimicrobial materials” (LAAMs). See Wilkinson, et al., “Rate Constants for the Decay and Reactions of the Lowest Electronically Excited Singlet State of Molecular Oxygen in Solution. An Expanded and Revised Compilation,” Journal of Physical and Chemical Reference Data, 24: 663-1021 (1995). Sherrill, et al., in “Grafting of Light-Activated Antimicrobial Materials to Nylon Films,” The Journal of Polymer Science, Part A Polymer Chemistry, Vol. 41, pages 41-47 (2003), describe various methods for synthesis of various derivatives of protoporphyrin and grafting such derivatives to nylon films. In a subsequent article, Bozja, et al. “Porphyrin-Based, Light-Activated Antimicrobial Materials,” Journal of Polymer Science, Part A Polymer Chemistry, Vol. 41, pages 2297-2303 (2003) teaches the antimicrobial properties of protoporphyrin grafted to nylon fibers. Further, US published patent application 2007/0238660 teaches a method of decontamination of microbial infected environments with the use of LAAMs attached to fabrics.

LAAMs generate a small amount of high energy state singlet oxygen, which has a very short life before it degenerates to ground state triplet oxygen, so at any time the amount of singlet oxygen is too low to pose a risk to human health. Therefore, the use of singlet oxygen generated by LAAMs holds the hope of an efficient antimicrobial agent that can be used in close proximity to humans or food for humans.

### BRIEF SUMMARY OF THE INVENTION

In a first aspect, the present invention provides a composition having 1) a light activated antimicrobial material that has one or more singlet oxygen generator groups, attached through 2) a linking group to 3) a mediator polymer capable of attaching to a substrate to form a surface that is capable of antimicrobial activity when illuminated in an oxygen containing environment, wherein, the linking group is a moiety of Formula I,

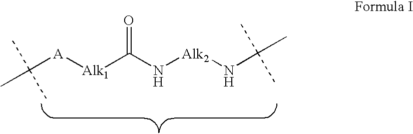

### or Formula II,

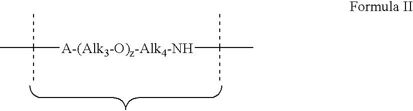 [0011] wherein A is O, S, or NH; Alk₁ and Alk₂ are independently C₂₋₁₂ straight or branched alkylene; Alk₃ is C₁₋₁₀ straight or branched alkylene; Alk₄ is C₂₋₁₀ straight or branched alkylene; and z is 1 -100;
   Preferably, the moiety of Formula I is a moiety of Formula Ia

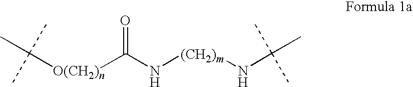

wherein n is 2 to 10 and m is 2 to 10;
   the moiety of Formula II is a moiety of Formula IIa

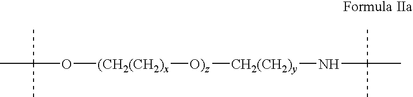

wherein x and y are independently 1-5, and z is 1-50;
the mediator polymer is polyacrylic acid (PAA), and the substrate has amino, or amino-equivalent functionality available for bonding to PAA.

More preferably, the moiety of Formula Ia is the moiety of Formula Ib,

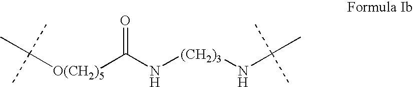

And the moiety of Formula IIa is the moiety of Formula IIB,

A-O—(CH₂)₂—O—(CH₂)₃—NH— Formula IIb

and the PAA mediator polymer has a molecular weight of about 50K to about 500K.

One specific embodiment of the first aspect is the composition:

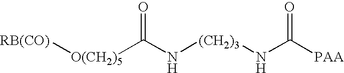

wherein RB is Rose Bengal (expressly showing its carboxylate group) or a dye having LAAM properties closely related to the Rose Bengal structure, such as erythrosine and eosine, and the PAA mediator polymer has a molecular weight of about 50K to about 500K. Where RB is Rose Bengal, the full chemical name for the composition of this embodiment is “2,3,4,5-tetrachloro-6-(6-hydroxy-2,4,5,7-tetraiodo-3-oxo-3H-xanthen-9-yl)-benzoic acid-5-(3-aminopropyl-carbamoyl)pentyl-polyacrylic acid.”

A second specific embodiment of the first aspect is the composition:

RB(CO)—O(CH₂)₂—O—(CH₂)₃NH-PAA
wherein RB is Rose Bengal (expressly showing its carboxylate group) or a dye having LAAM properties closely related to the Rose Bengal structure, such as erythrosine and eosine, and the PAA mediator polymer has a molecular weight of about 50K to about 500K. Where RB is Rose Bengal, the full chemical name for the composition of this embodiment is “2,3,4,5-tetrachloro-6-(6-hydroxy-2,4,5,7-tetraiodo-3-oxo-3H-xanthen-9-yl)-benzoic acid-3-(2-oxyethyl)-oxypropylamino-polyacrylic acid”

Other specific embodiments include:
Erthrosine-5- (3-aminopropylcarbamoyl)pentyl polyacrylic acid,
Eosine-5-(3-aminopropylcarbamoyl)pentyl polyacrylic acid,
Rose Bengal-5-(3-aminoethylcarbamoyl)pentyl polyacrylic acid,
Erthrosine-5-(3-aminoethylcarbamoyl)pentyl polyacrylic acid)
Eosine-5-(3-aminoethylcarbamoyl)pentyl polyacrylic acid,
Erthrosine-3-(2-oxyethyl)-oxypropylamino-polyacrylic acid, or
Eosine -3-(2-oxyethyl)-oxypropylamino-polyacrylic acid.

In a second aspect, the invention provides an antimicrobial surface to which is bonded the composition of the first aspect, wherein the antimicrobial surface is capable of antimicrobial activity when illuminated in an oxygen containing environment.

A third aspect of the invention is a method for preparing an antimicrobial surface of the second aspect comprising:
a) attaching one end of a linking group of Formula I or Formula II to a LAAM:
b) attaching the other end of the linking group to a mediator polymer to yield a LAAM modified mediator polymer;
d) attaching the LAAM modified mediator polymer to the substrate to form the antimicrobial surface.

A fourth aspect of the present invention is a method of deactivating microbes that come into close proximity to the antimicrobial surface of the second aspect, which is exposed to light in an environment containing oxygen.

### DETAILED DESCRIPTION OF THE INVENTION

As used herein, the following terms have the meanings indicated:
“Attach”, “affix”, and “bind” as used herein are synonymous and mean one or more moieties are joined by covalent molecular bonding, coating, impregnation, adsorption and other forms of firm attachment, but excludes ionic and electrostatic bonding.
“Deactivate” means to render microbes incapable of harming plants or animals. This term includes halting reproduction as well as destruction of microbes.
“Enveloped virus” means a virus that has an outer wrapping or envelope. This envelope comes from the infected cell or host in a process that is called “budding off.” During the budding process, newly formed virus particles become “enveloped” or wrapped in an outer coat that is made from a small piece of the cell's plasma membrane. The envelope may play a role in helping a virus survive and infect other cells.
LAAM(s) refers to light activate antimicrobial material(s). LAAMs are capable of generating low levels of antimicrobial singlet oxygen upon exposure to light while in an oxygen containing environment. May commercially used dyes are LAAMs.
“Linker group” refers to a moiety capable of covalently bonding to one or more LAAMs and also covalently bonding to a substrate directly or to a substrate through a mediator to attach the LAAMs to the substrate.
“Mediator polymer” or “amplifying polymer” means a polymer that attaches to reactive sites on the surface and creates many more reactive sites for attachment. It is, in effect, a surface site amplifying material.
“Microbes” are microscopic agents that include bacteria, fungi, viruses, and the like.
“Substrate” means at least one fiber, a fabric, or other types of surface, such as walls, wall coverings, paper, paint, plastic, and non-woven fabrics, and generally any surface to which dyes can be attached.
“Singlet oxygen” (or singlet molecular oxygen) is the common name used for one of the two metastable states of molecular oxygen (O₂) that has higher energy than the ground state triplet oxygen. See the paragraphs below for more details.

The ground state of normal oxygen has its two most energetic electrons arranged with parallel spin in a .π. molecular orbit to produce a state that is described as a spin triplet state represented by the spectroscopic notation .Σ. Situated 95 kJ above this state is a state where the electrons in the Δ_{g} molecular orbital have opposite spin yielding a spin singlet state Δ_{g}. It is this excited state (i.e. high energy state) that is commonly referred to as singlet oxygen; see Wilkinson, et al.(supra).

Certain materials are known to generate singlet oxygen from environmental oxygen upon exposure to light. Examples of such materials are flavons, xanthines, phenothiazines, phthalocyanines, aluminum phthalocyanines, protoporphyrin IX, and zinc-protoporphyrin IX, which are well-known dye materials, are known to generate singlet oxygen upon exposure to light or higher forms of electromagnetic radiation.

Singlet oxygen has been shown to exhibit strong antimicrobial effects. For example, see Dewilde, et al., “Virucidal activity of pure singlet oxygen generated by thermolysis of a water soluble naphthalene endoperoxide.” Journal of Photochemistry and Photobiology B: Biology 36(1): 23-29 (1996). Therefore, materials having this property are referred to herein as light activated antimicrobial material(s) or LAAM(s) for short. In certain environments, the use of LAAMs as singlet oxygen-generating materials, and hence, antimicrobials, may be limited by the amount of light exposure. Many dyes and similar materials are also LAAMs, and, in fact, most LAAMs referenced herein are commercially used as dyes.

It is possible to attach multiple molecules of a LAAM, directly or indirectly, to a single mediator polymer, which is attached to a substrate. A good example of such a mediator polymer is polyacrylic acid (PAA). Without PAA acting as a mediator or amplifier to bond the LAAM to the substrate, only one LAAM unit could be attached per attachment site of the substrate.

In addition to generating singlet oxygen upon exposure to light in an oxygen containing environment, LAAMs must also contain chemical moieties that allow them to be chemically bonded, directly or indirectly to the surface of a substrate such as a fabric. These include many of the dyes listed by Wilkinson, et al, (supra), including protoporphyrin IX, zinc protoporphyin IX, Rose Bengal, thionin, Azure A, Azure B, Azure C, proflavine, acriflavine, vinyl anthracene, 1-amino-9,10-anthraquinone, 1,5-diamino-anthraquinone, 1,8-diamino-anthraquinone, 1,8-dihydroxy-9,10-anthraquinone, 1-hydroxy-9,10-anthraquinone, 1,4,5,8-tetraamino-9,10-anthraquinone, 1,4,5,8-tetrahydroxy-9,10-anthraquinone, Eosine B, Eosine Y, Phloxin B, fluorescein, Erythrosine, tribromo-fluorescein, hypericin, kynurenic acid, riboflavine, chlorophyll a, chlorophyll b, coproporphyrin I, coproporphyrin II, coproporphyrin II, Ga protoporphyrin IX, clorin e6, proflavin, acroflavin, acridine yellow G, toluidine blue, anthracine derivatives, anthraquinones, tetracarboxyphthalocyanine, Sn tetracarboxyphthalocyanine, Al tetracarboxyphthalocyanine, Ge tetracarboxyphthalocyanine, 5-amino-etioporphyrin I, chlorin e6, as well as the zinc and aluminum derivatives of the above listed porphyrin and phthlocyanine derivatives. or other dyes that will be obvious to those skilled in the art. In addition, many other materials that generate singlet oxygen upon illumination can be used provided that they can be attached to the surface or to a mediator polymer.

US published patent application 2007/0238660 of Michielsen, et al., ('660), incorporated herein by reference, teaches a method of binding LAAM containing compositions to fabrics and other surfaces, which upon exposure to light and air, generate sufficient singlet oxygen to be effective against viruses. In particular, '660 states that materials prepared in accordance with its teaching can have the effect of neutralizing viruses of the type that are “enveloped”, such as influenza, vaccinia, and the like. The surfaces to which the LAAM containing compositions taught herein are attached have the same utility as stated in '660, but the present invention expands that utility by facilitating or making possible the preparation of compositions containing certain LAAMs, such as Rose Bengal and its congeners. Further, the present invention provides a method of attaching LAAMs to fabrics and other environmental surfaces not taught in '660.

Explicitly, '660 teaches reacting a LAAM having a carboxylic acid group, such as zinc protoporphyrin IX (Zn-PPIX), with ethylene diamine so that the carboxylic acid group and one of the amino groups of the ethylene diamine form an amide bond. Then the other amino group of the ethylene diamine is reacted with a carboxylic acid group onto a mediator polymer, such as polyacrylic acid (PAA) (previously affixed to a fabric substrate) to form an amide bond. Thus, the ethylene diamine moiety is a “coupling agent,” i.e., a “linker group,” connecting the LAAM to a mediator polymer, e.g., PAA moiety, which in turn is bonded to a substrate to give an antiviral material having the Formula:

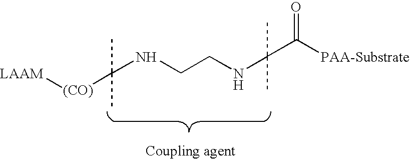

The linking groups, Formulas I and II (shown below), of the present invention afford substantial advantages over the alkylene diamines, e.g. ethylene diamine, coupling agent taught in '660 when the LAAM has carboxylic acid group available for binding. For example, these linking groups bind to certain carboxylic acid bearing LAAMs, e.g. Rose Bengal and its congeners, e.g. erythrosine and eosine, where the ethylene diamine coupling agent taught in '660 does not bind or does so with difficulty.

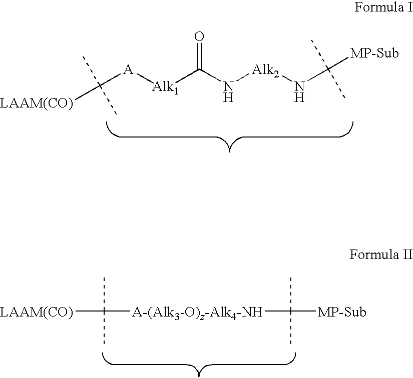

wherein LAAM(CO)— is a LAAM with its carboxylate function expressly shown; A is O, S, or NH; Alk₁ and Alk₂ are independently C₂₋₁₂ straight or branched alkylene; Alk₃ is C₁₋₁₀ straight or branched alkylene, and Alk₄ is C₂₋₁₀ straight or branched alkylene; and z is 1-100;
For both Formula I and II, MP is a mediator polymer having multiple functionality that allows multiple covalent bonding to the terminal amino functions of multiple linking groups of Formulas I or II, e.g. PAA; and Sub is a substrate having functionality that allows binding to the mediator polymer.

Thus, the present teaching expands and enhances the utility of attaching LAAMs to fabrics, as taught by '660, by facilitating or making possible the attachment of certain LAAMs, such as Rose Bengal and its congeners, to mediator polymers. That is, with certain LAAMs the teaching of the present invention allows the teaching of '660 to be practiced with greater efficiency and, hence, at lower cost.

Many LAAMs that have a free carboxylic acid group available for conjugating with hydroxy, thiol, or amino precursors of the linking groups of Formula I and Formula II (i.e., as the compounds of Formula III and Formula IV respectively) form conjugate ester, thioester, and amide bonds as shown in Schemes 1a and 1b. Such LAAMs are symbolically illustrated below in Schemes 1a and 1b as “LAAM(COOH)” and “LAAM(CO)—” to expressly depict the carboxylate group of interest. For example when the LAAM is Rose Bengal, the expressions “LAAM(COOH)” and “RB(COOH)” mean “2,3,4,5-tetrachloro-6-(6-hydroxy-2,4,5,7-tetraiodo-3-oxo-3H-xanthen-9-yl)-benzoic acid.” Pt denotes a protecting group.

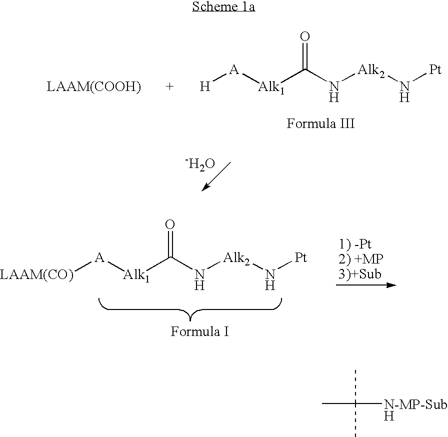

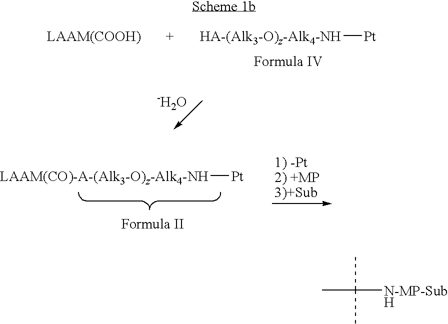

However, certain complex LAAMs conjugate only with great difficulty or do not conjugate at all. Such complex LAAMs as carboxylates typically have a large number of resonance forms whereby the negative charge of the carboxylate appears to be spread over multiple site the LAAM molecule As noted above, Rose Bengal dye (RB), which full nomenclature is “2,3,4,5-tetrachloro-6-(6-hydroxy-2,4,5,7-tetraiodo-3-oxo-3H-xanthen-9-yl)-benzoic acid,” is one such LAAM. Congeners of Rose Bengal include erthyrosine and eosine, which share the core structure and single carboxylic acid group with Rose Bengal but differ in their substituents. None-the-less, according to the present invention, Rose Bengal and other LAAMs bearing a carboxylic acid group that are not amenable to the reactions shown in Schemes 1a and 1b may be induced to yield ester bonding by the reactions of Schemes 2a and 2b.

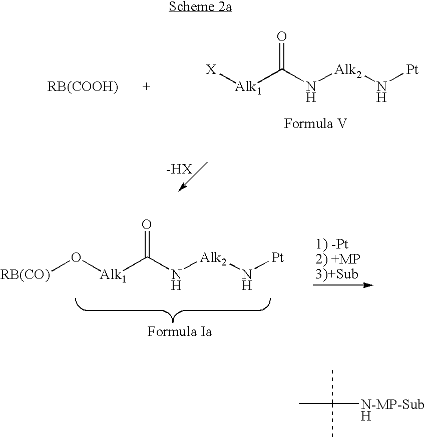

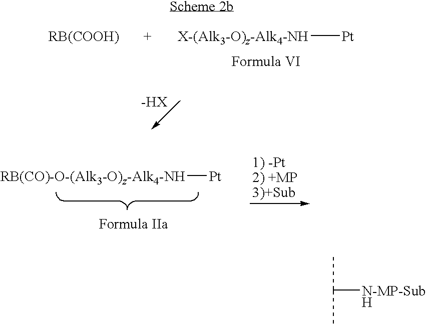

In Schemes 2a and 2b, X is a good leaving group such a halogen, Alk₁and Alk₂ are independently C₂₋₁₂ straight or branched alkylene; Alk₃ is C₁₋₁₀ straight or branched alkylene, and Alk₄ is C₂₋₁₀ straight or branched alkylene, and z is 1-100. Formulas Ia and IIa are the Formulas I and II respectively wherein A is O.

The conditions and techniques for executing the conjugations of Schemes 1a, 1b, 2a, and 2b are well known to those skilled in the art of organic chemistry and are discussed in detail in graduate level organic textbooks such as March's Advanced Organic Chemistry, 5^{th} Ed., John Wiley & Sons, Inc (2001). Likewise, where compounds of Formulas V and VI are not commercially available; their synthesis is well within the purview the artisan of ordinary skill. For example, to prepare a compound of Formula V, X-Alk₁-COOLv (X is halogen such as —Br and Lv is a leaving group such as —Cl, e.g. see March's page 275) with H₂N-Alk₂-NH—Pt (Pt is a protecting group such as —COO-tertbutyl). Further, specific, detailed illustrative examples are provided herein in the Example section. The skilled artisan will appreciate and accept that in some situations, multiple steps such as protecting and de-protecting sensitive groups may be required as well as adjusting conditions to optimize yield.

An antimicrobial surface may be prepared according to Schemes Ia and Ib and further illustrated in Examples 1and 2 by executing the following steps:
a) attaching one end of a linking group of Formula I or Formula II to a LAAM:
b) attaching the other end of the linking group to a mediator polymer to yield a LAAM modified mediator polymer;
d) attaching the LAAM modified mediator polymer to the substrate to form the antimicrobial surface.

Surfaces bearing one or more compositions of the first aspect of this invention may be employed to inactive microbes in an analogous manner as is taught in '006. That is, microbes coming in contact with the surface, or very close proximity (a few microns) of the surface in the presence of light will in effected by singlet oxygen. Microbes contacting the surface may be airborne or waterborne.

### EXAMPLES

The present invention is explained in greater detail through the following non-limiting Examples

### Example 1

### Preparation of Rose Bengal-5-(3-Aminopropylcarbamoyl)pentyl Poly(acrylic acid) Conjugate, 5% Loading, 450,000 MW PAA

### General Observation and Strategy:

Rose Bengal-5-(3-aminopropylcarbamoyl)pentyl poly(acrylic acid) conjugated with 5% loading on 450,000 MW poly(acrylic acid) may be synthesized in five steps according the route shown in Scheme 2a. That is, 6-Bromopentanoic acid 1 is converted to the corresponding acid chloride 2 by treatment with oxalyl chloride. Acid chloride 2 is reacted with (3-aminopropyl)carbamic acid tert-butyl ester. Bromo compound 3 is then reacted with Rose Bengal to give ester 5. The Boc protecting group is then removed by treatment with hydrogen chloride in dioxane to give rose bengal-5-(3-aminopropylcarbamoyl)phenyl ester hydrochloride. The conjugate (6) is prepared by reaction of poly(acrylic acid) with rose bengal-5-(3-aminoipropylcarbamoyl)-phenyl ester hydrochloride in the presence of DMTMM in water.

### Step 1. Synthesis of 6-Bromohexanoyl Chloride

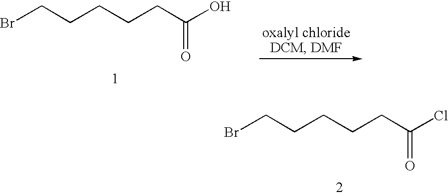

6-bromohexanoic acid was reacted with dichloromethane to make the reaction ˜1 M with respect to 6-bromohexanoic acid; DMF was added to reaction (1 drop for every 10 g of 6-bromohexanoic acid); next, oxalyl chloride (1.1 equivalents) was added. The reaction mixture was allowed to stir at ambient temperature overnight. The solvent was removed and the remaining oxalyl chloride was removed by rotary evaporation. Dichloroethane was added to the residue obtained via rotary evaporation. The resulting material was concentrated using rotary evaporation. Yield is 95%, nmr was consistent with product.

### Step 2. Synthesis of [3-(6-bromohexanoylamino)propyl]carbamic acid tert-butyl ester

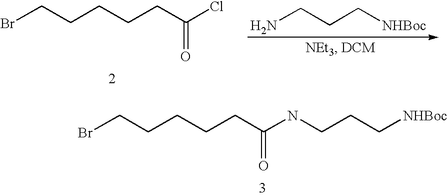

3-Aminopropyl)carbamic acid tert-butyl ester (1 equiv) and dichloromethane (as the solvent) were added to make the reaction ˜1 M with respect to 6-bromohexanoyl chloride. Next, triethylamine (10 equiv) was added, the reaction mixture was cooled in an ice/water bath and 6-bromohexanoyl chloride was added (at least 1 equiv). The reaction mixture was allowed to stir at 0° C. then warmed to ambient temperature. The solvent was removed by rotary evaporation, and ethyl acetate was added to the residue. The reaction mixture was washed with 10% aqueous sodium bisulfate three times (volume for each washing is equal to the volume of ethyl acetate), then the organic layer was dried over sodium sulfate, filtered or decanted, and concentrated by rotary evaporation.

### Step 3. Synthesis of 2,3,4,5-tetrachloro-6-(6-hydroxy-2,4,5,7-tetraiodo-3-oxo-3H-xanthen-9-yl)-benzoic acid 5-(3-tert-butoxycarbonylaminopropyl-carbamoyl)pentyl ester

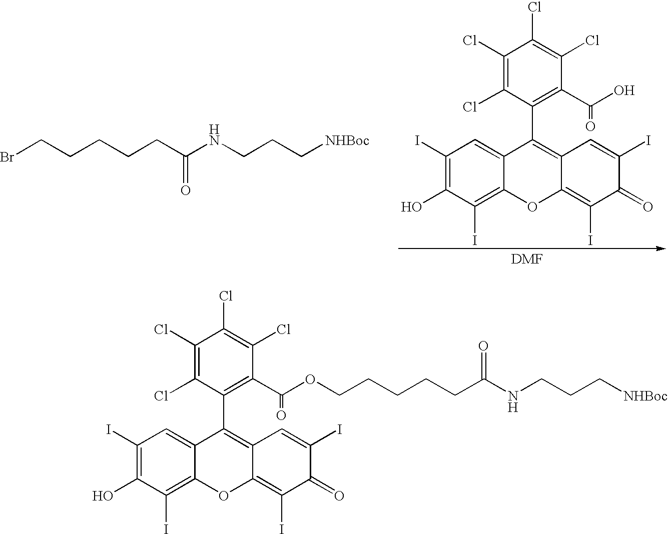

To [3-(6-bromohexanoylamino)propyl]carbamic acid tert-butyl ester (compound 3 (1 equiv) was added N,N-dimethylformamide (DMF) to make the reaction ˜0.5 M with respect to [3-(6-bromohexanoylamino)propyl]carbamic acid tert-butyl ester. After 2,3,4,5-tetrachloro-6-(6-hydroxy-2,4,5,7-tetraiodo-3-oxo-3H-xanthen-9-yl)-benzoic acid (compound 4, commonly know as Rose Bengal, (1.5 equiv) has been added, the reaction mixture was heated overnight at reflux. The reaction mixture was allowed to cool to ambient temperature and ethyl acetate was added in equal to volume of the DMF used for the reaction. Then water (2× the volume of ethyl acetate) and brine (equal to the volume of ethyl acetate) were added. The resulting layers were separated, the organic layer washed with brine four times, then dried over Na₂SO₄, filtered, and concentrated using a rotary evaporator give the product, compound 5.

### Step 4. Synthesis of 2,3,4,5-Tetrachloro-6-(6-hydroxy-2,4,5,7-tetraiodo-3-oxo-3H-xanthen-9-yl)-benzoic acid 5-(3-amino-propylcarbamoyl)pentyl ester hydrochloride

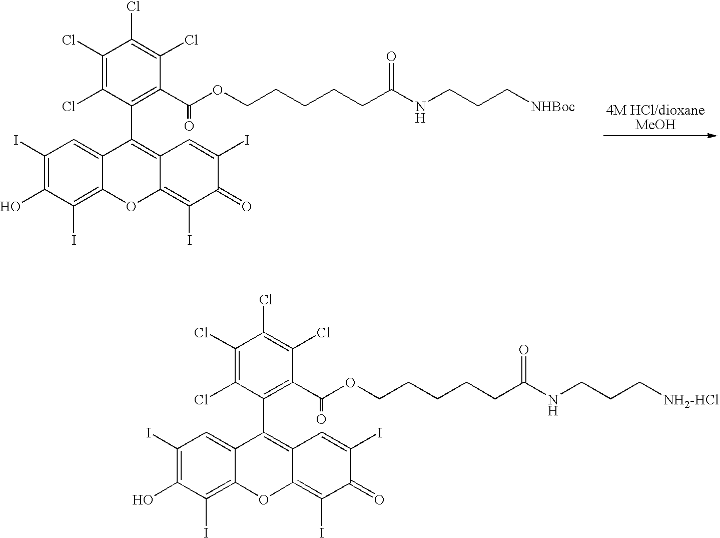

2,3,4,5-Tetrachloro-6-(6-hydroxy-2,4,5,7-tetraiodo-3-oxo-3 H-xanthen-9-yl)-benzoic acid 5-(3-tert-butoxycarbonylaminopropyl-carbamoyl)pentyl ester (abbreviated herein as “Rose Bengal -5-(3-tert-butoxycarbonylaminopropyl-carbamoyl)pentyl ester”), prepared in the previous step (1 equiv), and methanol (4× the volume of 4M HCl/dioxane required) were mixed and cooled to ˜0° C. in an ice bath. To this reaction mixture, 4M HCl/dioxane (2.5 equiv) was added drop wise. The reaction mixture was stirred overnight, allowing it to warm to ambient temperature. The solvent was removed via rotary evaporation and the resulting solid (compound 6) was washed with Et₂O to remove any remaining methanol, dioxane, or acid.

### Step 5. Synthesis of Rose-Bencial-5-(3-Aminopropylcarbamoyl)pentyl Polyacrylic acid Conjugate 5% Loading on 450,000 MW PAA

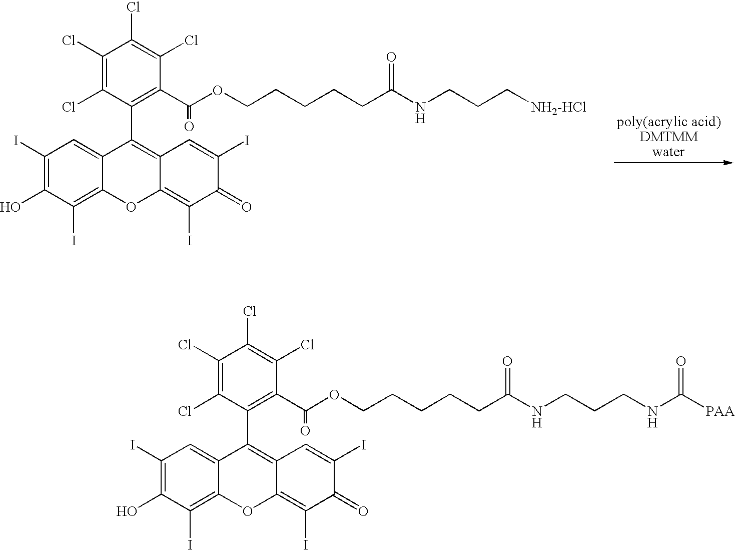

Polyacrylic acid (20 equiv (relative to Rose Bengal -5-(3-amino-propylcarbamoyl)pentyl ester hydrochloride, prepared in Step 4, “RBHCl”) and water (35 ml per gram of RBHCl) were heated to reflux until all of the poly(acrylic acid) had dissolved. After the solution was cool to ambient temperature, DMTMM (1.1 equiv), was added, and the reaction mixture was stirred for ˜5 min. To RBHCl (1 equiv), prepared in Step 4 is added DMF (1 mL of DMF per 1 g of RB-amine hydrochloride salt) and this mixture was warmed to dissolve all of the solid. The dissolved RBHCl was added to the poly(acrylic acid)/DMTMM mixture. After stirring overnight the reaction mixture was poured into dialysis tubing (molecular weight cutoff 15,000); and dialyzed against distilled water three times for 6 hour for each interval, changing the distilled water each time. The reaction mixture was then frozen, and water was removed by lyophylization to yield Rose-Bengal-5-(3-Aminopropyl-carbamoyl)pentyl Polyacrylic acid Conjugate. Physical data was consistent with structure.

The following compounds may by prepared by the procedure stated in Example 1 by make such modifications of reagents and conditions that would be understood by the skilled artisan.
Erthrosine-5-(3-aminopropylcarbamoyl)pentyl polyacrylic acid,
Eosine-5-(3-aminopropylcarbamoyl)pentyl polyacrylic acid,
Rose Bengal-5-(3-aminoethylcarbamoyl)pentyl polyacrylic acid,
Erthrosine-5-(3-aminoethylcarbamoyl)pentyl polyacrylic acid,
Eosine-5-(3-aminoethylcarbamoyl)pentyl polyacrylic acid,
Rose Bengal-3-(2-oxyethyl)-oxypropylamino-polyacrylic acid,
Erthrosine-3-(2-oxyethyl)-oxypropylamino-polyacrylic acid, and
Eosine-3-(2-oxyethyl)-oxypropylamino-polyacrylic acid.

### Example 2

### Coupling of Antimicrobial Compound to a Fabric to Form an Antimicrobial Surface

Five gallons of 0.01% w/w aqueous solution of a soluble Rose Bengal dye polymer, which was prepared by dissolving solid Rose Bengal photodynamic polymer (made in step 5 of Example 1) in cold water. This solution was padded continuous onto a 1.0 osy [ounce/square yard], 60″ wide, non-woven nylon to yield an 85% pickup [w/w of dye polymer solution to fabric weight] of solution. Fabric with dye polymer solution is immediately passed through an 8 foot, 175° C. forced air drying oven at a speed of 3 yards/minute, wherein the fabric surface temperature reaches 172° C. (Hunter a* value of 10.8).

### Example 3

### Effectiveness of Antimicrobial Surface

A modification of ASTM E 2149 was used to measure the bactericidal effects of the singlet oxygen produced by the fabric. Bacteria were inoculated onto the LAAM fabric (prepared in Example 2) which was then irradiated with visible light. The bacteria were then extracted from the fabric and diluted in saline. The viability of the diluted bacteria was determined by plating them onto a solid nutrient medium and incubating them in an environment that is favorable to growth. Growth was evidenced by the development of discrete colonies which could be counted. Results are showed in Table 1. Increasing light intensity resulted in increasing antibacterial activity.

TABLE 1
Antibacterial Activity of RB-PAA-Fabric

| | Reduction of Variable |
|---|---|
| Light Intensity | S. aureus |
| (Lux) | [Log 10] |
| 0 | 0 |
| 2500 | 0.9 |
| 5000 | 2.9 |
| 10,000 | 4.0 |

What is claimed is:

1. A composition comprising:
a) a light-activated antimicrobial material that has one or more singlet oxygen generator groups and a carboxylic acid group,
b) a mediator polymer capable of attaching to a substrate to form a surface that is capable of antimicrobial activity when exposed to light in an oxygen containing environment, and
c) a linking group connecting the light activated antimicrobial material to the mediator polymer,
wherein, the linking group is a moiety of Formula I, 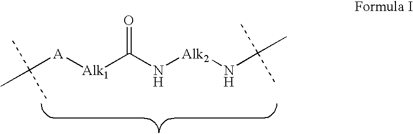
or Formula II, 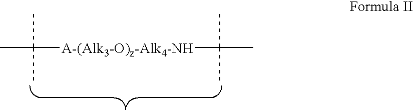
wherein A is O, S, or NH; Alk₁and Alk₂ are independently C₂₋₁₂ straight or branched alkylene; Alk₃ and is C₁₋₁₀ straight or branched alkylene; Alk₄ is C₂₋₁₀ straight or branched alkylene; and z is 1-100; MP is a mediator polymer having multiple functionality that allows multiple covalent bonding to the terminal amino functions of multiple linking groups of Formulas I or II; and Sub is a substrate having functionality that allows binding to the mediator polymer.

2. The composition of claim 1 wherein the linking group is a moiety of Formula Ia or IIa 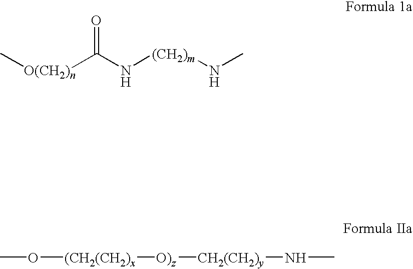
wherein n is 2 to 10; m is 2 to 10; x and y are independently 1-3, and z is 2-50; and the mediator polymer is polyacrylic acid having a molecular weight from about 50K to about 500K.

3. The composition of claim 2 wherein the moiety of Formula Ia is the moiety of Formula Ib 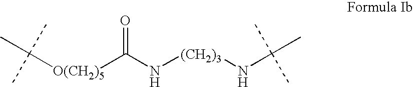
and the moiety of Formula IIa is the moiety of Formula IIb.
A-O—(CH₂)₂—O—(CH₂)₃—NH— Formula IIb

4. The composition of claim 3 wherein the light-activated antimicrobial material is RB is Rose Bengal, erythrosine, or eosine.

5. The compound of claim 4, which is:
Rose-Bengal-5-(3-Aminopropylcarbamoyl)-pentyl Polyacrylic acid,
Erthrosine-5-(3-aminopropylcarbamoyl)pentyl polyacrylic acid,
Eosine-5-(3-aminopropylcarbamoyl)pentyl polyacrylic acid,
Rose Bengal-5-(3-aminoethylcarbamoyl)pentyl polyacrylic acid,
Erthrosine-5-(3-aminoethylcarbamoyl)pentyl polyacrylic acid,
Eosine-5-(3-aminoethylcarbamoyl)pentyl polyacrylic acid,
Rose Bengal-3-(2-oxyethyl)-oxypropylamino-polyacrylic acid,
Erthrosine-3-(2-oxyethyl)-oxypropylamino-polyacrylic acid, or
Eosine-3-(2-oxyethyl)-oxypropylamino-polyacrylic acid.

6. An antimicrobial surface comprising a substrate to which is bonded the composition of the claim 1.

7. The antimicrobial surface of claim 6 wherein the composition of claim 1 is the composition of claim 2.

8. The antimicrobial surface of claim 6 wherein the composition of claim 1 is the composition of claim 3.

9. The antimicrobial surface of claim 6 wherein the composition of claim 1 is the composition of claim 4.

10. The antimicrobial surface of claim 6 wherein the composition of claim 1 is the composition of claim 5.

11. A method for preparing the antimicrobial surface of claim 6 comprising:
a) attaching one end of a linking group that is the moiety of Formula I or Formula II of claim 1 to a light-activated antimicrobial material:
b) attaching the other end of the linking group to a mediator polymer to yield a light-activated antimicrobial material modified mediator polymer;
d) attaching the light-activated antimicrobial material modified mediator polymer to the substrate to form the antimicrobial surface.

12. The method of claim 11 wherein the linking group is the moiety of Formula Ia or Formula IIa of claim 2, the mediator polymer is PAA is polyacrylic acid having a molecular weight from about 50K to about 500K, and the substrate is a fabric or environmental surface.
